(19) United States
(12) Patent Application Publication
(10) Pub. No.: US 2002/0029389 A1
(43) Pub. Date: Mar. 7, 2002

(54) Information service system linked to broadcasting system

(76) Inventor: Makoto Kimura, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/910,908

(22) Filed: Jul. 24, 2001

(30) Foreign Application Priority Data
Jul. 24, 2000 (JP) 222008/2000

(51) Int. Cl. H04N 7/173

(52) U.S. Cl. 725/91

(57) ABSTRACT

An information service system linked to a broadcasting system is provided which comprises at least one content provider, a broadcasting center and user sides. The content provider multicasts a content over the Internet to users. The broadcasting center broadcasts a program signal which contains an index for identifying the content after the content provider multicasts it. The user's facilities comprise a storage device for storing the content multicast from the content provider, an extraction device for extracting the index from the broadcast signal, an indication device, in response to the extraction of the index, for indicating that the index corresponding to the content previously stored in the storage device, has been received. When a user pushes a predetermined key of a PC terminal while the indication device indicates the reception of the index, a content corresponding to the index is read from the storage device and displayed on the PS screen.

### BACKGROUND OF THE INVENTION

The present invention relates generally to an information service system linked to a broadcasting system, and more particularly to an information service system which can provide users with content information associated with a normal broadcasting program.

From the inauguration of the first digital satellite broadcasting utilizing a communication satellite (CS) to the digital broadcasting utilizing a broadcasting satellite (BS), the digitization of broadcasting is still under progress. It has been announced that substantially all broadcasting, including terrestrial broadcasting, is scheduled to be digitized in several years in Japan. Using a digital multiplexing technique utilized in the digitization of broadcasting, a large amount of Information can be embedded or multiplexed in a normal program video/audio signal to be broadcast.

Likewise, in the current analog broadcasting system, data broadcasting is under way such as text multiplexed broadcasting system, VBI (vertical blanking Interval) system, and so on, wherein data is multiplexed on a normal program broadcasting signal.

Such an information service system linked to a data multiplex broadcasting system has been provided in which an URL of a content provider on the Internet is broadcast in a multiplexing form in a normal broadcasting program signal and stored at a user, and the user can visit a web page addressed by the URL and carrying content information corresponding to the program, when he or she manipulate a predetermined key during the presentation of the program on a television screen. In the system, however, for instance if event information on a concert or the like having a good reputation is broadcast together with a URL, a sudden increase may be expected in the number of users attempting to access a web page of the associated content provider. This may cause a server of the provider having a relatively low processing capacity to shut down.

To overcome the above problem, another information service system has been provided. In the second prior system, a content itself is previously broadcast in a multiplexing form in a normal broadcasting program signal and stored at a user side. The content is automatically displayed on a TV screen when a program associated with the content is broadcast and displayed thereon. In the second prior system, since the content is stored at the user side before the associated program is broadcast, the user does not need to visit a web page of a content provider, resulting in that an amount of communication traffic will not increase.

However, in the second prior system, the content is automatically displayed, together with the normal program on the TV screen regardless of interests of the user viewing the program. Such automatic presentation of a content together with a normal program on the same TV screen may sometimes cause a user annoying. In the result, such an information service system would not propagate. In addition, a large amount of content data must be multiplexed in a normal broadcasting program signal, and if a user's TV receiver is not under an ON state during the broadcasting, the content data cannot be received and registered at the user side.

### SUMMARY OF THE INVENTION

The present invention has been made in view of the foregoing problems encountered in the prior arts, and an object of this invention is to provide an information service system which is capable of improving the problems.

To achieve the above object, in a first aspect of the present invention, it provides an information service system linked to a broadcasting system, comprising:

at least one content provider for multicasting at least one content over the Internet to users:

a broadcasting center for broadcasting a program signal which contains an index for identifying the content after the content provider multicasts it; and

facilities of each of the user sides, which comprise:

a monitor device for receiving and displaying the broadcast program signal;

a storage device for storing the content multicast from the content provider:

an extraction device for extracting the index from the broadcast signal;

indication device, in response to the extraction of the index, for indicating that the index corresponding to the content previously stored in the storage device, has been received:

a manipulation device including at least a content presentation button manipulated by the user;

an information presentation device for presenting the content; and

a retrieving device, in response to the manipulation of the content presentation button by the user while the indication device indicates the reception of the index, for retrieving a content corresponding to the index from the storage device to provide the information presentation device.

In a second aspect of the present invention, it provides an information service system linked to a broadcasting system, comprising:

at least one content provider for multicasting at least one combination of a content and an index over the Internet to users, the content being associated with a program which is broadcast from a broadcasting center, and the index containing at least a time period during which the program is being broadcast; and

facilities of each of the user sides, which comprise:

a monitor device for receiving and presenting the broadcast program signal;

a storage device for storing the content multicast from the content provider;

a manipulation device including at least a content presentation button manipulated by the user;

an information presentation device for presenting the content; and

a retrieving device, in response to the manipulation of the content presentation button by the user while the indication device indicates the reception of the index, for retrieving a content having an index containing a time period including the current time of the manipulation, from the storage device to provide the information presentation device.

In a third aspect of the present invention, it provides an information service system linked to a broadcasting system, comprising:

a broadcasting center for broadcasting a program signal in which a combination of a content and an index containing a time period during which the content is available to a user, is multiplexed;

at least one content provider for providing at least one content to the broadcasting center, thereby the content together with the index is multiplexed in the program signal; and

facilities of each of user sides, which comprise:

a monitor device for receiving and displaying the broadcast program signal:

an extraction device for extracting the content and index from the broadcast signal;

a storage device for storing the extracted content and index:

an indication device, in response to the extraction of the content and index, for indicating during the time period contained in the index that the content has been available from the storage device;

a manipulation device including at least a content presentation button manipulated by the user:

an information presentation device for presenting the content; and

a retrieving device, in response to the manipulation of the content presentation button by the user while the indication device indicates the availability of the content, for retrieving the content from the storage device to provide the information presentation device.

In a fourth aspect of the present invention, it provides an information service system linked to a broadcasting system, comprising:

a broadcasting center for broadcasting program signals in which indexes containing the same URL are multiplexed; and

at least one content provider for providing one of contents on a web page addressed by the URL of the index, the web page contents respectively corresponding to the program contents, the content provider having a table representing a relationship between the web page contents and the indexes,

the content provider updating the content on the web page when it detects that the broadcasting program and thus index are updated, with reference to the relation table.

### BRIEF DESCRIPTION OF THE DRAWINGS

FIG. 1 is an explanatory diagram illustrating a first embodiment of an information service system according to the present invention;

FIG. 2 is an explanatory diagram illustrating a second embodiment of an information service system according to the present invention; and

FIG. 3 is an explanatory diagram illustrating a third embodiment of an information service system according to the present invention;

### DETAILED DESCRIPTION OF THE INVENTION

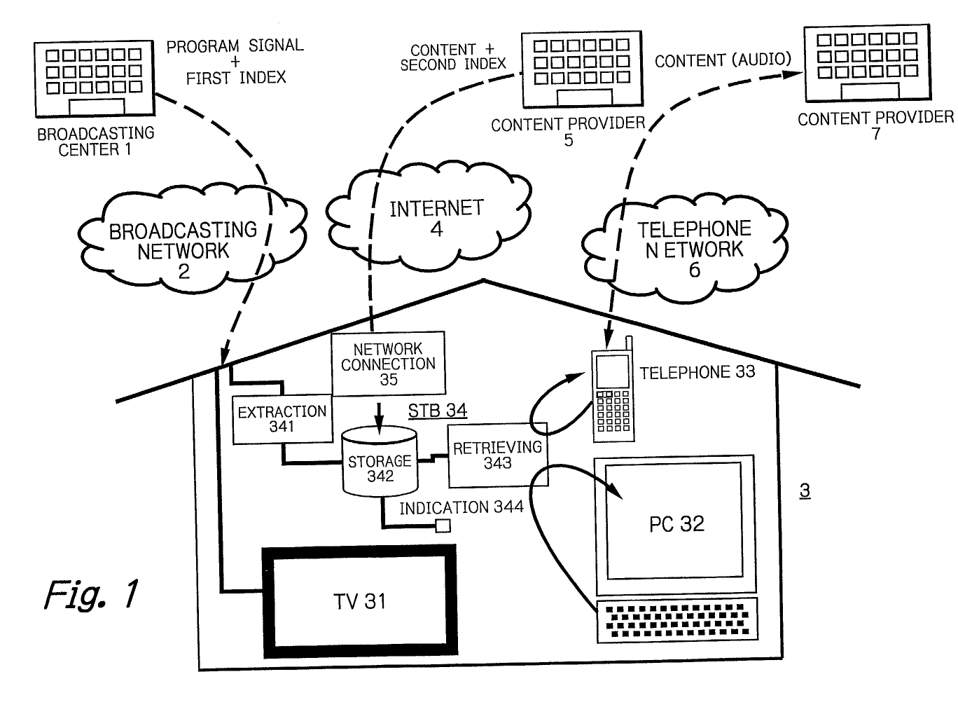

FIG. 1 shows an explanatory diagram of a first embodiment of an information service system according to the present invention. The system comprises a broadcasting center 1 of a broadcasting service entity, a broadcasting network 2, facilities 3 at a user side, the Internet 4, a content provider 5 connected to the Internet 4, a telephone network 6, a content provider 7 (call center) connected to the telephone network 6. The facilities 3 contain at least one user terminal connectable to the content provider 5 and/or 7 through the Internet 4 and/or the telephone network 6. Each of the content providers 5 and 7 is an advertisement or publicity information provider of an organization such as an enterprise, country, local authority and so on (hereinafter represented by an “advertiser”), and is possible to communicate through the Internet 4 and/or the telephone network 6 with the user terminal. The content provider 5 can provide video and/or audio contents for advertisement and/or publicity while the content provider 7 can provide only audio contents on the telephone network 6.

As illustrated in FIG. 1, the user facilities 3 include a television receiver set 31, a personal computer (or PC) terminal 32, a telephone 33, a set top box (STB) 34, and a network connection device 35. One of the PC terminal 32 and telephone 33 may be neglected, and the PC terminal 32 may not be required if the TV receiver set 31 has the same function as that of the PC terminal 32. A personal digital assistant (PDA) terminal may be utilized as a user terminal.

The STB 34 contains an extractor (or tuner) 341 for extracting a predetermined data multiplexed in a normal broadcasting program signal, an information storage device 342, information retrieving device 343, and an indication device 344. It is possible to utilize a storage device and information retrieve function of the PC terminal 32 as the devices 342 and 342, respectively. Further, it is possible to incorporate the STB 34 in the TV set 31.

Next, an operation of the information service system shown in FIG. 1 will be explained in a case where the PC terminal 32 is used as a user manipulation device. The telephone 33, a PDA (not shown), or a TV set having the PC function may be utilized as the user manipulation apparatus.

The broadcasting center 1 multiplexes an index (a first index) in a normal program signal. Before broadcasting the multiplexed signal from the center 1, the content provider 5 prepares a content corresponding to the broadcasting program and an index (a second index) and multicasts the combination thereof to users 3 through the Internet 4. The content may be detailed information of broadcast information in the normal program. The content and the second index are received by the network connection device 35 at a user side and then stored in the storage device 342. As is explained hereinafter, it is not always necessary for the first and second indexes to have the same data structure, provided that they are associated with each other by a predetermined means.

When the first index in the normal program signal broadcast from the center 1 is reached at a user, it is extracted by the extractor 341 and then registered in the storage device 342. Simultaneously therewith, the indication device 344 is driven to indicate the user that a content corresponding to the currently broadcasting program has been stored and can be reproduced on the PC terminal 32. The indication by the indication device 344 may be displayed at a corner on the screen of the TV set 31. Alternatively, the indication may be implemented as illumination of a lamp located at a portion of the TV set 31 or the STB 34. Further, it may be displayed on a screen of the PC terminal 32.

During the indication by the device 344, when the user pushes a content presentation button which has been previously selected from the keys of the PC terminal 32, the information retrieving device 343 read out the newest first index from the storage device 343. The content presentation button may be the “#” key, for instance, but any other key could be selected. Subsequently, the retrieving device 343 retrieves one of the second indexes which has a relationship to the read-out first one, in the storage device 342, and finally reads and transfers a content having the retrieved second index to the PC terminal 32, where the content is reproduced. Therefore, the user can obtain the content (or detailed information) corresponding to the currently broadcasting program. Since a content has been multicast over the Internet 4 before broadcasting the associated program, it is not necessary to multiplex content data having a relatively a large volume, and a problem relating to the communication traffic on the Internet 4 may not be arisen.

A user also can reproduce any of the contents stored in the storage device 342 even after broadcasting the corresponding normal programs. In order to reproduce one of them, the retrieving device 343 reads only the second indexes in a storage device 342 upon being requested from the PC terminal 32 and transfers them thereto. A table including the second indexes is displayed on the PC screen, and hence the user can select anyone of the second indexes in the table. Upon selecting the second index, the information retrieving device 343 retrieves and transfers the corresponding content in the storage device 342 to the PC terminal 32, where it is reproduced. Therefore, it is preferable for the second indexes to contain data representing summaries of the contents.

It is further preferable for a user to visit any web page of a content provider 5 with reference to the displayed second index table. Therefore, the second index multicasted from the content provider 5 preferably includes its URL. More further, it is desirable for the user to visit the web page only with one manipulation of selecting one of the second indexes, by embedding linking information in the second index. Thus, a user can visit any web page (e.g., purchase order page) of a content provider 5 without inputting a URL from a keyboard of his or her PC terminal 32. It is also preferable to automatically register the URLs in the second indexes as bookmarks.

The following data structure is one example of the second index multicasted from a content provider 5.

```
<index
  stream=”tv://nhk”
  region=”jpn”
  uri=”http://www.mediagram.co.jp/cgi-bin/nhk”
  type=”text/html”
  start=”Sat Jul 14 00:00:00 2001”
  expire=”Sun Jul 15 00:00:00 2001”
  comment=”program association data broadcasting by
mediagram”
/>
```

The first index which is multiplexed in a normal broadcasting program signal may not have the same information as that of the second index, if the second index is retrievable by the first index. Alternatively, it is also possible that the first index contains the above information and the second index contains information which is retrievable by the first index.

In the above description, an example, where a combination of a content and a second index is multicast to users via the Internet 5, and a first index only is multiplexed to a normal program broadcasting signal is described. However, it may not be necessary to multiplex the first index to the program broadcasting signal, if an item regarding an effective time period during which the program relating to the content will be broadcast, is included as the second index.

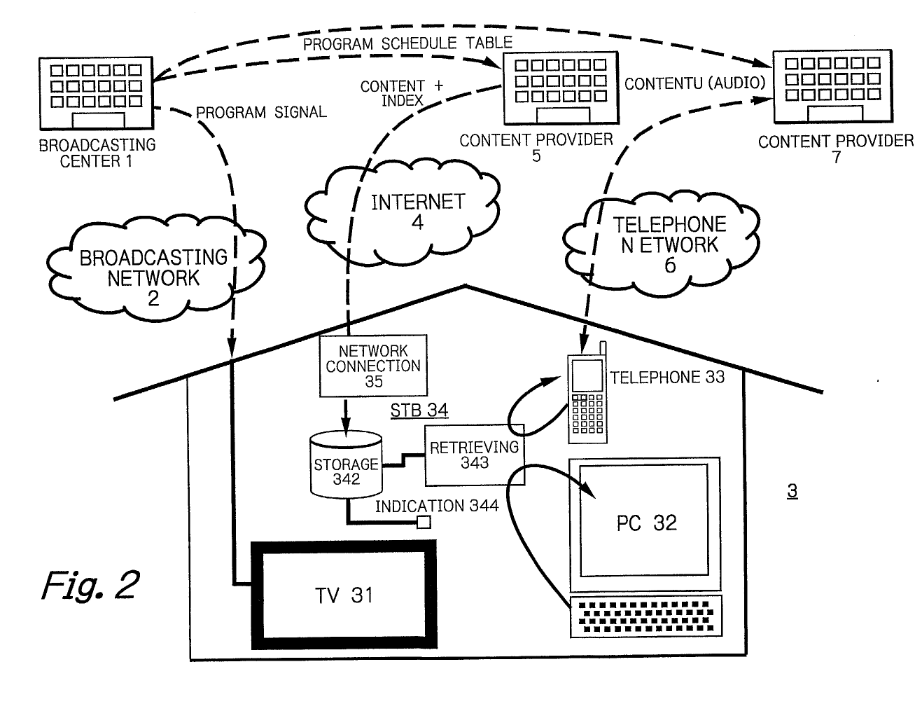

FIG. 2 shows a schematic diagram of an information service system according to the present invention, which does not require the first index to be multiplexed and broadcast.

In the second embodiment, the broadcasting center 1 communicates to the content provider 5 (and the content provider 7), in advance, the program information which contains the broadcasting time period of a program relating to a content to be provided from the provider 5. In response to the program information from the center 1, the content provider 5 generates an index which includes the effective time period, and then, the index is added to a content which correspond to the program. The content with the index is then multicasted to users over the internet 4 and registered in the information storage device 342. For example, it may be preferable to conduct multicasting of the content with index during a time period (for example, in the early morning of the broadcasting day of the program) that an amount of traffic on the Internet 4 is relatively low.

A user is able to know that contents relating to normal programs are already stored in their own storage devices 342, by checking marks inserted in a programming table of a newspaper, magazine, etc., or listening to announcements which are made during broadcasting of the programs. Also, during the effective time period, which is included in the index stored in the storage device 342, the indication device 344 works to inform the user that a content relating to the program is available. When the user manipulates a content presentation button pre-selected on the PC terminal 32 in a one-touch manner during he or she is listening/watching the program, the retrieving device 343 reads the content, to which the index including the effective time period has been added, from the storage device 342, and transfers and presents it on the screen of the PC terminal 34.

In the second embodiment, it is possible that the index includes all items of the second index which is described in relation to the first embodiment. Also, it is possible that the index includes only items of the effective time period. In the former case, as described above, a user can retrieve any of the stored contents after a program is broadcast, and visit a web page of the corresponding content provider 5.

In the above description, a case where a content is presented on the PC terminal 32 is explained. However, if the telephone terminal 33 is connectable to the Internet 4, the content can be presented thereon. Also, if a content is comprised of audio information only, the audio content can be sent to the telephone terminal 33 from the content provider 7 through the telephone network 6. In this case, the audio content is stored in a storage device of the telephone terminal 33.

Also, if a broadcasting program is an animation program, it may be possible to configure the information service system to reproduce the content on a rag doll of a character (animal) or a robot. In this case, the voice content of the character (animal) of the animation program is sent to a user terminal in advance from the content provider 5 or 7 via the Internet 4 or the telephone network 6. Further, a content presentation button and content reproduction device are provided on and in the rag doll of the character (animal) or a robot. The audio content stored in the user terminal will be reproduced when a child who is an audience of the animation program, pushes the presentation button.

In the first embodiment described above, the broadcasting center 1 can be a TV broadcasting station or a radio broadcasting station, and a program broadcasting signal can be a digital signal or an analog signal as long as a first index can be multiplexed therein. In the second embodiment, the broadcasting center 1 can be a TV broadcasting station or a radio broadcasting station, also. Further, in the second embodiment, since it is not necessary to multiplex any index information to a program broadcasting signal, the type of the broadcasting signal is not essential.

It is contemplated that the Internet 4 will be used as a broadcasting network, and it is needless to say that the present invention is applicable to such a system.

Since the first and second embodiments of the present invention is constructed as explained above, a user can listen to/watch a content relating to a broadcasting program by performing a one-touch manipulation. Further, since the content is sent from a content provider via the Internet or a telephone network and stored in users in advance to broadcasting of the associated program, the traffic to a web page or the like of the content provider may not be increased.

In addition, since the content is not multiplexed in the program broadcasting signal and is multicast via the Internet or telephone network, even if the user's TV set is not ON-state when the content is transmitted, or even if he or she is watching another TV channel program which is not related to the content, the content can be stored in the user side.

The first embodiment can be modified by multiplexing a content as well as an index at an initial part of a broadcasting signal of a program associated with the content. They may be multiplexed in another program broadcasting signal which is not associated with the content but is broadcast before the content corresponding program signal is broadcast. In the modified system, the content and index are broadcast, extracted by the extractor 341 and stored in the storage device 342 in advance to the corresponding program broadcasting. Accordingly, as explained with reference to the first and second embodiments, the content can be presented at the user terminal (PC terminal 32 or telephone terminal 33) when a user manipulates the content presentation button thereon during the effective time period (or during broadcasting of the corresponding program.

The first embodiment can be further modified such that the broadcasting center 1 and the content provider 5 (and 7) can associate with each other and the broadcasting center 1 multiplexes contents in program broadcasting signals, instead of previously multicasting them from the content provider 5 via the Internet 4. In the second modified system, the content provider 5 provides a web page on the Internet 4 addressed by a URL, contents on which respectively are switched correspondingly to those of program signals broadcast from the broadcasting center 1. The content provider 5 retains a table representing a relationship between the web page contents and programs. An advertisement (or event) content containing the URL is multiplexed in the program broadcasting signal. Only the URL may be multiplexed in the program signals if the programs themselves contain information relating to the web page contents. The advertisement contents may be provided the broadcasting center 1 from the content provider 5.

In the second modified system, the broadcasting center 1 broadcasts each of the program signals on the basis of a broadcasting time schedule, and simultaneously with each program broadcasting, notifies the content provider 5 of the advertisement content multiplexed in the broadcast signal. This allows the content provider 5 to know which advertisement content is broadcast and when it is done, and therefore, to switch or update a content on the web page to that corresponding to the currently broadcasting content, based on the table. The notification information of the currently broadcasting advertisement content to the content provider 5 may be executed via the Internet 4, the broadcasting network 2, or a dedicated line therebetween.

Thus, the content provider 5 can change the previous content to the new content on the web page, in response to the notification information from the center 1, resulting in that the web page contents certainly corresponding to the broadcasting advertisement contents can be presented even though they are addressed by the same URL. It will be apparent to that a telephone number may be multiplexed in a program broadcasting signal instead of the URL. In this case, audio sources of an automatic audio response system in the content provider 7 addressed by the telephone number may be switched in response to the notifying information.

Since the multiplexed and broadcast advertisement content and web page content are changed in association, this is significantly advantageous when the content provider 5 or 6 is an advertisement agent or the like.

The second modified system may be further arranged to include two modes, one of which is that the multiplexed contents are broadcast from the broadcasting center 1, as just described above, and the other of which is that the contents are previously multicast from the content provider 5 as described with reference to the first embodiment. In order to achieve the two mode, a URL presentation button is for the first mode and a content presentation button for the second mode should be provided on the PC terminal 32 on the telephone terminal 33.

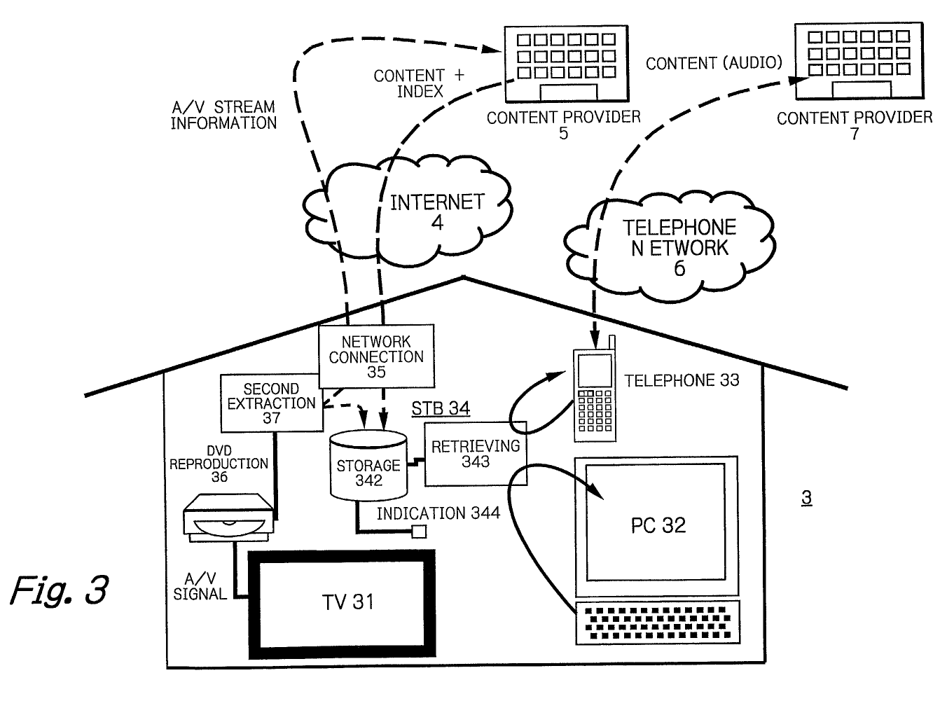

FIG. 3 shows a schematic diagram of a third embodiment of an information service system according to the present invention. The third embodiment is constituted by adding a DVD reproduction device 36 (or, A/V stream reproduction device), and a second extractor 37 to the second embodiment of FIG. 2, and deleting the broadcasting center 1 and network 2.

In the third embodiment, the content provider 5 multicasts combinations of contents and indexes which are associated with DVDs, to users before the DVDs are released. The contents and indexes are stored in the storage device 342 at user sides. When a user who has obtained one of DVDs, starts to reproduce it at the reproduction device 36, the A/V stream information for specifying the title of the DVD picture is extracted by the second extractor 37. The extracted A/V stream information is stored in the storage device 342 and when the user manipulates a content presentation button of the PC terminal 32, the retrieving device 343 reads out a content corresponding to the A/V stream information and transfers it to the PC terminal 32, where it is reproduced. The contents associated with the DVD pictures are multicasted to the users in advance to their release in the third embodiment, the traffic of the Internet 4 or telephone network 6 may not be increased even after the release.

While preferred embodiments of the present invention has been described using specific terms, such description is for illustrative purposes only, and it is to be understood that changes and modifications of the examples may be made without departing from the sprit or scope of the following claims.

What is claimed is:

1. An information service system linked to a broadcasting system, comprising:
at least one content provider for multicasting at least one content over the Internet to users;
a broadcasting center for broadcasting a program signal which contains an index for identifying the content after the content provider multicasts it: and
facilities of each of the user sides, which comprise:
a monitor device for receiving and displaying the broadcast program signal;
a storage device for storing the content multicast from the content provider;
an extraction device for extracting the index from the broadcast signal;
indication device, in response to the extraction of the index, for indicating that the index corresponding to the content previously stored in the storage device, has been received;
a manipulation device including at least a content presentation button manipulated by the user;
an information presentation device for presenting the content; and
a retrieving device, in response to the manipulation of the content presentation button by the user while the indication device indicates the reception of the index, for retrieving a content corresponding to the index from the storage device to provide the information presentation device.

2. A system according to claim 1, wherein
the content provider is further adapted to add a second index to the content, and to multicast the combination of the content and second index over the Internet to the user sides, the second index being associated with the first index;
the storage device at the user is further adapted to store the second index;
the retrieving device at the user side further comprises means for retrieving all of the second indexes in the storage device and transfer them to the information presentation device: and
the manipulation device at the user side further includes a selection means for selecting one of the second indexes on the information presentation device.

3. A system according to claim 2, wherein
the retrieving device is further adapted, when the user select one of the second indexes using the selection means on the information presentation device, to retrieve the content corresponding to the selected second index and to provide it to the information presentation device.

4. A system according to claim 3, wherein each of the second indexes contains a URL of the content provider, and thus the content information presentation device presents the URL of the content provider.

5. A system according to claim 4, wherein the manipulation device further comprises means for selecting on of the presented URLs on the information presentation device; and
the facilities at the user side further contain means, upon selecting one of the URLs, for automatically browsing a web page addressed by the selected URL.

6. A system according to claim 1, wherein at least one of the indication device, manipulation device, information presentation device and retrieving device is incorporated in a user terminal connectable to the Internet.

7. A system according to claim 1, wherein the monitor device and information presentation device are the same device.

8. An information service system linked to a broadcasting system, comprising;
at least one content provider for multicasting at least one combination of a content and an index over the Internet to users, the content being associated with a program which is broadcast from a broadcasting center, and the index containing at least a time period during which the program is being broadcast; and
facilities of each of the user sides, which comprise:
a monitor device for receiving and presenting the broadcast program signal;
a storage device for storing the content multicast from the content provider:
a manipulation device including at least a content presentation button manipulated by the user;
an information presentation device for presenting the content; and
a retrieving device, in response to the manipulation of the content presentation button by the user while the indication device indicates the reception of the index, for retrieving a content having an index containing a time period including the current time of the manipulation, from the storage device to provide the information presentation device.

9. A system according to claim 8, the facilities at the user side further comprises an indication device which, in response to the extraction of the index, indicates that the index corresponding to the content previously stored in the storage device, has been received.

10. A system according to claim 8, wherein at least one of the indication device, manipulation device, information presentation device and retrieving device is incorporated in a user terminal connectable to the Internet.

11. A system according to claim 8, wherein the monitor device and information presentation device are the same device.

12. An information service system linked to a broadcasting system, comprising:
a broadcasting center for broadcasting a program signal in which a combination of a content and an index containing a time period during which the content is available to a user, is multiplexed;
at least one content provider for providing at least one content to the broadcasting center, thereby the content together with the index is multiplexed in the program signal; and
facilities of each of user sides, which comprise:
a monitor device for receiving and displaying the broadcast program signal;
an extraction device for extracting the content and index from the broadcast signal;
a storage device for storing the extracted content and index;
an indication device, in response to the extraction of the content and index, for indicating during the time period contained in the index that the content has been available from the storage device;
a manipulation device including at least a content presentation button manipulated by the user;
an information presentation device for presenting the content; and
a retrieving device, in response to the manipulation of the content presentation button by the user while the indication device indicates the availability of the content, for retrieving the content from the storage device to provide the information presentation device.

13. A system according to claim 12, wherein the monitor device and information presentation device are the same device.

14. A system according to claim 12, wherein at least one of the indication device, manipulation device, information presentation device and retrieving device is incorporated in a user terminal connectable to the Internet.

15. An information service system linked to a broadcasting system, comprising:
a broadcasting center for broadcasting program signals in which indexes containing the same URL are multiplexed: and
at least one content provider for providing one of contents on a web page addressed by the URL of the index, the web page contents respectively corresponding to the program contents, the content provider having a table representing a relationship between the web page contents and the indexes,
the content provider updating the content on the web page when it detects that the broadcasting program and thus index are updated, with reference to the relation table.

16. A system according to claim 15, further comprising facilities of each of user sides, which comprise:
a monitor device for receiving and displaying the broadcast program signal;
an extraction device for extracting the index from the broadcast signal;
a storage device for storing the extracted and index;
an indication device, in response to the extraction of the index, for indicating that the URL has been available from the storage device;
a manipulation device including a URL presentation button manipulated by the user;
an information presentation device for presenting the content:
a retrieving device, in response to the manipulation of the URL presentation button by the user while the indication device indicates the availability of the content, for retrieving the URL in the index from the storage device; and
means for automatically browsing the content currently presented on the web page of the content provider, on the information presentation device, upon retrieving the URL by the retrieving device.

17. A system according to claim 16, wherein the monitor device and information presentation device are the same device.

18. A system according to claim 16, wherein at least one of the indication device, manipulation device, information presentation device and retrieving device is incorporated in a user terminal connectable to the Internet.

19. A system according to claim 16,
the content provider is further adapted to multicast the same contents as those to be presented on the web page before broadcasting the corresponding to the program contents to the users where the web page contents are stored in the storage device:
the extraction device is further adapted to extract the web page content from the broadcast signal;
the storage device is further adapted to store the web page content:
the indication device is further adapted, in response to the extraction of the content, to indicate that the web page content has been available from the storage device;
the manipulation device further comprises a content presentation button; and
the retrieving device is further adapted, in response to the manipulation of the content presentation button by the user while the indication device indicates the availability of the content, to retrieving the content from the storage device to provide the information presentation device.
